(19) United States
(12) Patent Application Publication
(10) Pub. No.: US 2002/0195306 A1
(43) Pub. Date: Dec. 26, 2002

(54) Oneway clutch device

(75) Inventors: Tomoharu Ando, Fukuroi-shi (JP); Hirobumi Shirataki, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 10/176,653

(22) Filed: Jun. 24, 2002

(30) Foreign Application Priority Data
Jun. 25, 2001 (JP) 2001-191619
Apr. 19, 2002 (JP) 2002-118344

(51) Int. Cl. F16D 41/067

(52) U.S. Cl. 192/45

(57) ABSTRACT

A oneway clutch device comprises a plurality of rollers interposed between an inner race and an outer race to transmit torque only at the time of relative rotation between the inner race and the outer race in one rotational direction, a spring for biasing these rollers toward a direction of engagement, and a retainer having a flange portion to be fitted on the inner race and a plurality of column portions and adapted to retain the rollers and the spring. The spring has a nip portion formed and bent to have a section substantially in a U form for nipping and retaining therebetween one of the column portions of the retainer. There is formed at least one latch means for preventing movement or falling off of the spring.

This application claims the benefit of Japanese Patent applications No. 2001-191619 and No. 2002-118344 which are hereby incorporated by reference.

### BACKGROUND OF THE INVENTION

1. Field of the Invention

The present invention relates to a oneway clutch device for constituting an automatic transmission, or the like, for a car, and particularly to a technology for facilitating a conveying work, or the like.

2. Related Background Art

Generally, an automatic transmission for a car is provided with a planetary gear mechanism of about three to five speed levels, in addition to a torque converter serving as a fluid joint, and effects speed change by properly fixing or releasing the constituent elements (a sun gear, a planetary gear, and the like) of the planetary gear mechanism by the use of frictional engagement means such as a clutch or a brake. As the frictional engagement means to be assembled in the automatic transmission, a wet-type multiple disc in which friction plates and separator plates are alternately disposed is used, except in some band brakes. A pressure oil from a transmission control oil pressure circuit is used for pressure-contact (frictional engagement) between the both plates. Also, there is partially employed, as the frictional engagement means, a member which realizes easier transmission control by incorporating therein a oneway clutch device and freely rotate a gear shaft, or the like, in one rotational direction.

FIG. 52 is a principal and longitudinal sectional view for showing a oneway clutch device of a sprag type to be assembled in the frictional engagement means. The oneway clutch device 111 comprises an inner race 5 having an oil path 113 formed to open on the outer peripheral surface thereof, an outer race 9 rotatably supported to be coaxially and relatively with respect to the inner race 5, a oneway clutch mechanism 115 interposed between the inner race 5 and the outer race 9, etc. The oneway clutch mechanism 115 is composed of a large number of sprags 117 serving as torque transmission members, a ribbon spring 119 for holding the sprags 117 and, at the same time, for biasing the sprags 117 toward the direction of engagement, an outer retainer 121 for retaining the ribbon spring 119 in an annular form, an inner retainer 123 for restraining an excessive inclination of the sprag 117 in cooperation with the outer retainer 121, a pair of end bearings 125 for holding the both retainers 121, 123 with a predetermined distance therebetween to secure an operation of the sprag 117, and side plates 127, 129 for regulating an axial movement of each of these components.

A oneway clutch device 111 of this type is normally used in a state in which the inner race 5 is rotated while the outer race 9 is fixed, but is used not in a few cases in a state that the inner race 5 is fixed and the outer race 9 is rotated. In these cases, since it is difficult for lubricating oil to enter between the inner race 5 and the sprag 117 or the end bearing 125, it is feared that abrasion or scorching will be generated on a slide surface due to a defective lubrication. Also, since the end bearings 125 are the parts requiring high precision, high processing cost thereof turns to be high, which resultantly increases a unit price of the oneway clutch device 111. Accordingly, it has been discussed to employ a roller type oneway clutch device in which rollers are interposed between the inner race and the outer race as a torque transmission member and cam surfaces are formed on the inner race. The roller type oneway clutch device comprises as its constituent parts a spring for biasing the roller to the direction of engagement, block bearings for forming a predetermined gap between the inner race and the outer race, and a retainer to be fitted on the inner race for retaining the roller, the spring, and the block bearings.

In the roller type oneway clutch device described above, while the above-described problems can be solved, a drag torque in idling time can be reduced. However, there arises another kind of problems that, during conveyance, the spring may fall off, or the position of the spring may easily deviate. That is, in the roller type oneway clutch device, since serving as an output shaft or an input shaft of the automatic transmission, or the like, the outer race defined as a constituent element does not naturally exist as a sub-assembly prior to the assembling of the automatic transmission, or the like. Accordingly, if any impact is applied during the conveyance of the sub-assemblies, the spring may fall off comparatively easily or the position of the spring may deviate. In this case, a product defined as defective is required to be treated separately, which resultantly deteriorates the working efficiency.

### SUMMARY OF THE INVENTION

An object of the present invention is, taking the above circumstances into consideration, to provide a oneway clutch which is contrived to secure retention of a spring by a retainer so as to enhance the efficiency of the assembling work.

In order to solve the above problems, according to a first aspect of the present invention, there is proposed a oneway clutch device which comprises a plurality of rollers interposed between an inner race and an outer race to transmit torque only in a relative rotation of the inner race and the outer race in one rotational direction, a spring for biasing these rollers toward a direction of engagement, and a retainer having a flange portion to be fitted on the inner race and a plurality of column portions, adapted to retain the rollers and the spring, and in which the spring has a nip portion formed and bent to have a section substantially in a U form for nipping and retaining with pressure one of the column portions of the retainer, and there is formed at least one latch means for preventing the spring from moving or falling off.

According to this invention, if any impact is applied during conveyance of the sub-assemblies, the spring latched by the latch means does not easily fall off.

In the oneway clutch device according to the first aspect of the present invention, one of said latch means may be a latch protrusion which is formed on the outer diameter side of said column portion for latching said nip portion in order to regulate the movement of the spring in the direction of the outer diameter.

According to this structure, it is possible to prevent the spring from falling off in the radial direction.

In the oneway clutch device according to the first aspect of the present invention, one of said latch means may be a latch portion which is formed to be extended from the tip end of the nip portion so as to be engaged with the column portion of said retainer.

According to this structure, it is possible to prevent an axial movement of the spring.

In the oneway clutch device according to the first aspect of the present invention, one of said latch means may be a contact portion which is formed to be folded back at the tip end of the nip portion so as to be brought into contact with the flange portion of said retainer.

According to this structure, it is possible to prevent an axial movement of the spring.

In the oneway clutch device according to the first aspect of the present invention, one of said latch means may be a contacting protrusive piece which is formed to be protruded from the bent portion of the nip portion so as to be engaged with the flange portion of said retainer.

According to this structure, it is possible to prevent an axial movement of the spring.

In the oneway clutch device according to the first aspect of the present invention, one of said latch means may be a slit which is formed in the column portion so as to receive the bent portion of the nip portion.

According to this structure, it is possible to prevent an axial movement of the spring.

In the oneway clutch device according to the first aspect of the present invention, one of said latch means may be comprised of the bent portion which is formed to be extended from the tip end of the nip portion to have a section substantially in an L form and a retaining portion which is formed in the column portion for retaining the bent portion.

According to this structure, it is possible to prevent an axial movement of the spring.

In the oneway clutch device according to the first aspect of the present invention, one of said latch means may be comprised of a recessed portion which is formed in the column portion and a fit portion which is formed in the nip portion to be fitted in the recessed portion.

According to this structure, it is possible to prevent an axial movement of the spring.

In the oneway clutch device according to the first aspect of the present invention, one of said latch means is comprised of a convex portion which is formed in the column portion and an engagement portion which is formed in the nip portion to be engaged with the convex portion.

According to this structure, it is possible to prevent an axial movement of the spring.

In the oneway clutch device according to the first aspect of the present invention, one of said latch means comprises a through hole which is formed among said plurality of column portions of the retainer and a protrusive portion which is formed to be protruded from the nip portion to be fitted in the through hole.

According to this structure, it is possible to prevent an axial movement of the spring.

In the oneway clutch device according to the first aspect of the present invention, one of said latch means comprises a through hole which is formed among said plurality of column portions of the retainer and a fit latching portion having a substantially L shape, which is formed to be protruded from the nip portion and fitted in the through hole to be latched.

According to this structure, it is possible to prevent an axial movement of the spring.

In the oneway clutch device according to the first aspect of the present invention, the column portion may have a chamfered portion in the end portion on the outer diameter side thereof, in order to facilitate an assembling work of the spring.

According to this structure, the spring is guided to the chamfered portion when it is attached to the column portion so as to be easily folded out.

In the oneway clutch device according to the first aspect of the present invention, the spring may have a folded-back portion in the end portion on the inner diameter side, in order to facilitate the assembling work of the spring into the column portion.

According to this structure, the spring is easily folded out when it is attached to the column portion since the spring starts to contact with the column portion at the folded-back portion.

According to a second aspect of the present invention, there is proposed a oneway clutch device which comprises a plurality of rollers interposed between an inner race and an outer race to transmit torque only at a time of a relative rotation between the inner race and the outer race in a one rotational direction, a spring for biasing these rollers toward a direction of engagement, and a retainer having a flange portion to be fitted on the inner race and a plurality of column portions and adapted to retain the rollers and the spring, and in which the spring has a retaining portion formed and bent to have a section substantially in a Z form for elastically contacting with and retaining one of the column portions of the retainer, a slit through which the bent portion of the nip portion is formed to be fitted in the column portion, and at least one latch means is formed for preventing movement or falling off of the spring.

According to this invention, if any impact is applied during conveyance of the sub-assemblies, the spring latched by the latch means does not easily fall off.

In the oneway clutch device according to the second aspect of the present invention, one of said latch means may be a latch protrusion which is formed on the outer diameter side of said column portion for latching said retaining portion in order to regulate the movement of the spring in the direction of the outer diameter.

According to this structure, it is possible to prevent the spring from falling off in the radial direction.

### BRIEF DESCRIPTION OF THE DRAWINGS

FIG. 1 is a front view of a oneway clutch device according to a first embodiment of the present invention;

FIG. 2 is a sectional view taken along line A-A in FIG. 1;

FIG. 3 is a view of a portion indicated by the arrow B in FIG. 1;

FIG. 4A is a view of a portion indicated by the arrow C in FIG. 3;

FIG. 4B is an enlarged view of a portion 4B in FIG. 4A;

FIG. 5 is a principal enlarged view of a oneway clutch device according to a second embodiment of the present invention;

FIG. 6 is a principal enlarged view of a oneway clutch device according to a third embodiment of the present invention;

FIG. 7 is a principal enlarged view of a oneway clutch device according to a fourth embodiment of the present invention;

FIG. 8 is a sectional view taken along line D-D in FIG. 7;

FIG. 9 is a view of a portion indicated by the arrow E in FIG. 7;

FIG. 10 is a view of a portion indicated by the arrow F in FIG. 7;

FIG. 11 is a principal enlarged view of a oneway clutch device according to a fifth embodiment of the present invention;

FIG. 12 is a view of a portion indicated by the arrow G in FIG. 11;

FIG. 13 is a sectional view taken along line H-H in FIG. 11;

FIG. 14 is a principal enlarged view of a oneway clutch device according to a sixth embodiment of the present invention;

FIG. 15 is a view of a portion indicated by the arrow J in FIG. 14;

FIG. 16 is a sectional view taken along line K-K in FIG. 14;

FIG. 17 is a principal enlarged view of a oneway clutch device according to a seventh embodiment of the present invention;

FIG. 18 is a view of a portion indicated by the arrow L in FIG. 17;

FIG. 19 is a sectional view taken along line MM in FIG. 17;

FIG. 20 is a principal enlarged view of a oneway clutch device according to an eighth embodiment of the present invention;

FIG. 21 is a view of a portion indicated by the arrow N in FIG. 20;

FIG. 22 is a sectional view taken along line O-O in FIG. 20;

FIG. 23 is a principal enlarged view of a oneway clutch device according to a ninth embodiment of the present invention;

FIG. 24 is a view of a portion indicated by the arrow P in FIG. 23;

FIG. 25 is a sectional view taken along line Q-Q in FIG. 23;

FIG. 26 is a principal enlarged view of a oneway clutch device according to a tenth embodiment of the present invention;

FIG. 27 is a view of a portion indicated by the arrow R in FIG. 26;

FIG. 28 is a sectional view taken along line S-S in FIG. 26;

FIG. 29 is a principal enlarged view of a oneway clutch device according to an eleventh embodiment of the present invention;

FIG. 30 is a view of a portion indicated by the arrow T in FIG. 29;

FIG. 31 is a sectional view taken along line U-U in FIG. 29;

FIG. 32 is a principal enlarged view of a oneway clutch device according to a twelfth embodiment of the present invention;

FIG. 33 is a view of a portion indicated by the arrow V in FIG. 32;

FIG. 34 is a sectional view taken along line W-W in FIG. 32;

FIG. 35 is a principal enlarged view of a oneway clutch device according to a thirteenth embodiment of the present invention;

FIG. 36 is a view of a portion indicated by the arrow X in FIG. 35;

FIG. 37 is a sectional view taken along line Y-Y in FIG. 35;

FIG. 38 is a principal enlarged view of a oneway clutch device according to a fourteenth embodiment of the present invention;

FIG. 39 is a view of a portion indicated by the arrow A1 in FIG. 38;

FIG. 40 is a sectional view taken along line B1-B1 in FIG. 38;

FIG. 41 is a principal enlarged view of a oneway clutch device according to a fifteenth embodiment of the present invention;

FIG. 42 is a sectional view taken along line C1-C1 in FIG. 41;

FIG. 43 is a sectional view taken along line D1-D1 in FIG. 41;

FIG. 44 is a principal enlarged view of a oneway clutch device according to a sixteenth embodiment of the present invention;

FIG. 45 is a sectional view taken along line E1-E1 in FIG. 44;

FIG. 46 is a sectional view taken along line F1-F1 in FIG. 44;

FIG. 47 is a principal enlarged view of the oneway clutch device according to the sixteenth embodiment;

FIG. 48 is a principal enlarged view of a oneway clutch device according to a seventeenth embodiment of the present invention;

FIG. 49 is a sectional view taken along line G1-G1 in FIG. 48;

FIG. 50 is a sectional view taken along line H1-H1 in FIG. 48;

FIG. 51 is a principal plan view of an accordion spring according to the seventeenth embodiment; and

FIG. 52 is a principal longitudinal sectional view for showing a conventional oneway clutch device.

### DETAILED DESCRIPTION OF THE PREFERRED EMBODIMENTS

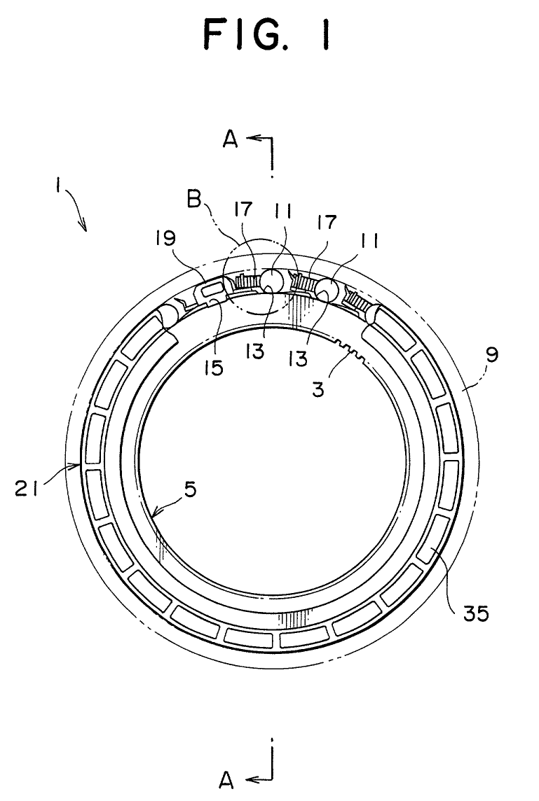

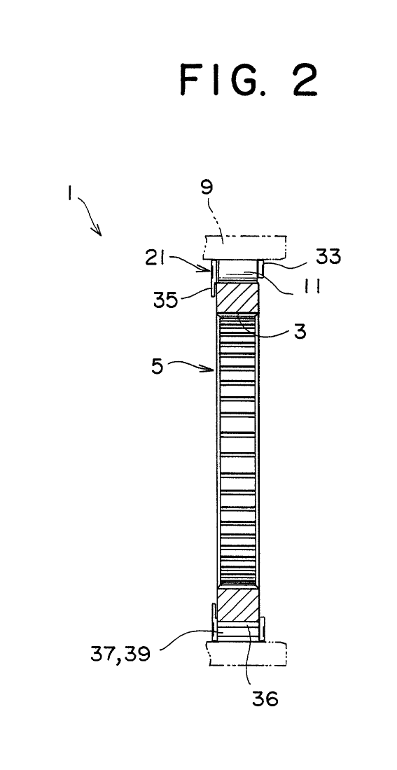

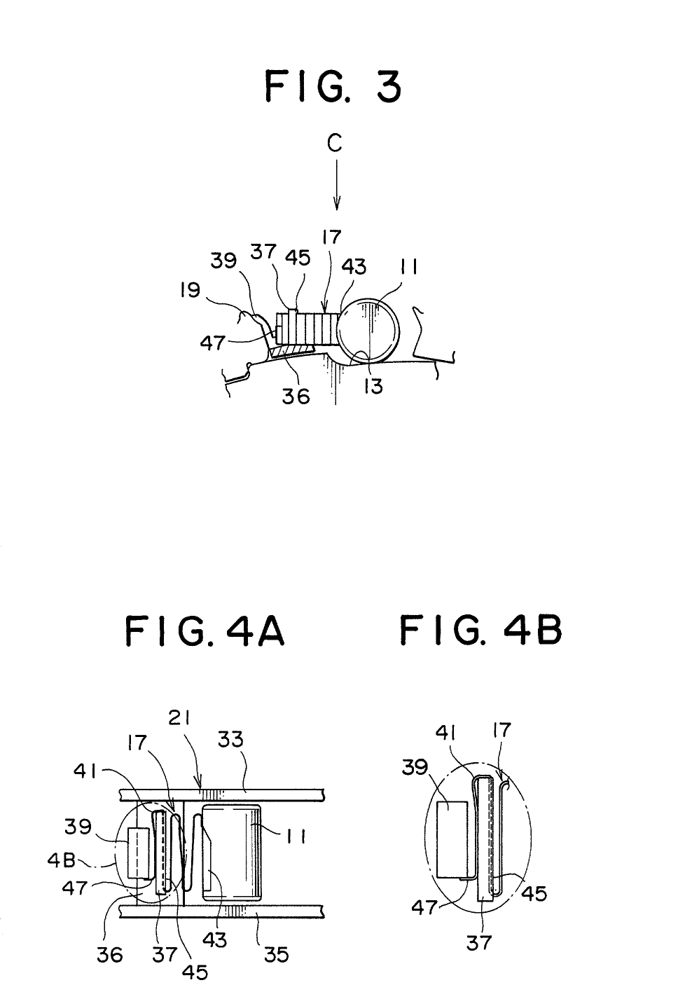

Several embodiments of a oneway clutch device according to the present invention will be fully described below with reference to the drawings. FIG. 1 is a front view of a oneway clutch device according to the first embodiment of the present invention. FIG. 2 is a sectional view taken along line A-A in FIG. 1, FIG. 3 is a view of a portion indicated by the arrow B in FIG. 1, and FIGS. 4A and 4B are views of a portion indicated by the arrow C in FIG. 3. The oneway clutch device of the present embodiment is built in an automatic transmission of a car which, however, has no relation with the gist of the invention. Consequently, description of the automatic transmission will be omitted.

As shown in FIG. 1 and FIG. 2, the oneway clutch device 1 comprises an annular inner race 5 which has a spline 3 on the inner peripheral surface thereof, a cylindrical outer race 9 which is disposed coaxially and relatively rotatably with respect to the inner race 5, a large number of rollers 11 interposed between the inner race 5 and the outer race 9 to serve as torque transmission members, and the like. On the outer peripheral surface of the inner race 5, there are formed a plurality of cam surfaces 13 formed along the circumferential direction and a plurality of bearing retaining grooves 15 formed along the axial direction. Each of the rollers 11 is disposed between the inner peripheral surface of the outer race 9 and the cam surface 13, and is biased by an accordion spring 17 inside the cam surface 13 toward the direction of engagement.

A block bearing 19 which is formed of oil-impregnated sintered alloy is fitted in and retained by each of the bearing retaining grooves 15, and the distance between the inner race 5 and the outer race 9 is maintained by the block bearing 19. Referring to FIG. 1 through FIGS. 4A and 4B, a retainer 21 prepared by injection-molding of synthetic resin such as nylon or polypropylene, is disposed to retain the rollers 11, the accordion spring 17, and the block bearings 19 between the inner race 5 and the outer race 9.

The retainer 21 comprises first and second flange portions 33, 35, a large number of connection units 36 for connecting both the flange portions 33, 35 to each other, and a large number of column portions including first and second column portions 37, 39 formed to be protruded from these connection units 36 radially outwardly.

As shown in FIG. 3 and FIGS. 4A and 4B, the first column portion 37 is formed to have a comparatively long length in the axial direction, and is nipped in a nip portion 41 which is formed in the end portion on the fixed side of the accordion spring 17 and is bent to have a substantially U-shaped section. The second column portion 39 is formed to have a comparatively short length in the axial direction and to be bent at the tip end thereof so as to retain the block bearing 19. In the drawings, a roller pressing portion 43 is formed on the free end of the accordion spring 17.

In case of the first embodiment, a latch protrusion 45 is formed at the tip end of the first column portion 37 to be protruded toward the roller 11 side. An end portion on the outer diameter side of the nip portion 41 is latched by the latch protrusion 45. On the other hand, in the accordion spring 17, the tip end of the nip portion 41 is formed in a latch portion 47 which is bent to have a substantially L-shaped section, and the latch portion 47 is engaged with a side surface of the second column portion 39.

In the first embodiment, as having such a structure, the accordion spring 17 is prevented from moving in the direction of the outer diameter by the latch protrusion 45 and, at the same time, from moving in the axial direction by the latch portion 47. Thereby, there arises no fall-off of the accordion spring 17 during the conveyance of the sub-assemblies, and no movement, or the like, of the accordion spring 17 at the time of driving.

FIG. 5 is a principal enlarged view of a oneway clutch device according to the second embodiment of the present invention. The entire structure of the second embodiment is the same as that of the first embodiment described above, except for a method of latching the accordion spring 17 in the axial direction. More specifically, in the second embodiment, the latch portion 47 is formed to be bent in the direction opposite to that of the first embodiment, and is engaged with the side surface of the first column portion 37. However, like in the first embodiment, the accordion spring 17 is prevented from moving in the direction of the outer diameter by the latch protrusion 45 and, at the same time, from moving in the axial direction by the latch portion 47.

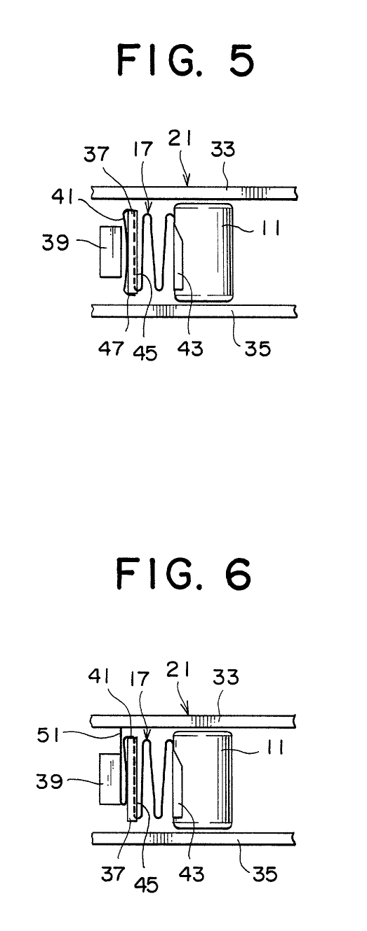

FIG. 6 is a principal enlarged view of a oneway clutch device according to the third embodiment of the present invention. The entire structure of the third embodiment is also the same as that of the first embodiment described above, except for a method of latching the accordion spring 17 in the axial direction. More specifically, in the third embodiment, a contact portion 51 is formed to be extended from the tip end of the nip portion as if being turned back thereat, and this contact portion 51 is brought into contact with the inner surface of the first flange portion 33 of the retainer 21. Thereby, like in the first embodiment, the accordion spring 17 is prevented from moving in the direction of the outer diameter by the latch protrusion 45 and, at the same time, from moving in the axial direction by the contact portion 51.

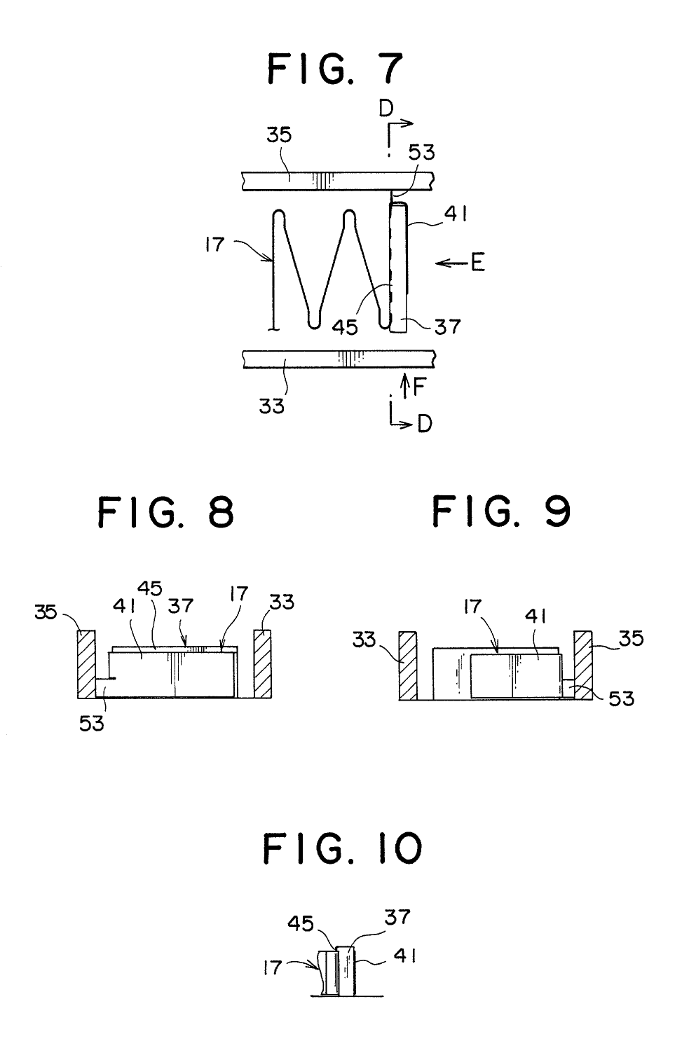

FIG. 7 is a principal enlarged view of a oneway clutch device according to the fourth embodiment of the present invention, FIG. 8 is a sectional view taken along line D-D in FIG. 7, FIG. 9 is a view of a portion indicated by the arrow E in FIG. 7, and FIG. 10 is a view of a portion indicated by the arrow F in FIG. 7. The entire structure of the fourth embodiment is also the same as that of the first embodiment described above, except for a method of latching the accordion spring 17 in the axial direction. More specifically, in the fourth embodiment, a contact protrusive piece 53 is formed to be extended from a bent portion of the nip portion 41 as if being cut up thereat, and this contact protrusive piece 53 is brought into contact with the inner surface of the second flange portion 35 of the retainer 21. Thereby, like in the third embodiment, the accordion spring 17 is prevented from moving in the direction of the outer diameter by the latch protrusion 45 and, at the same time, from moving in the axial direction by the contact protrusive piece 53.

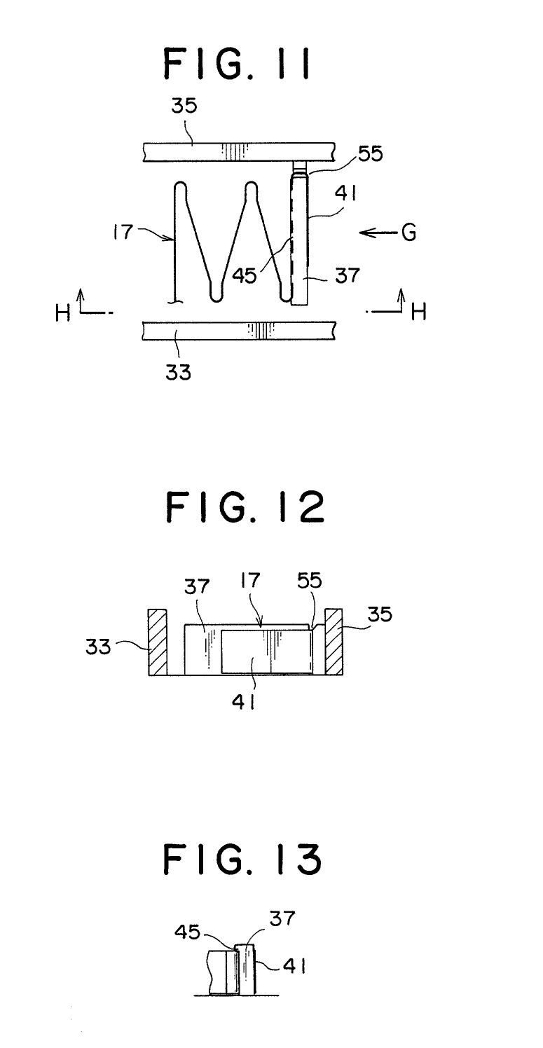

FIG. 11 is a principal enlarged view of a oneway clutch device according to the fifth embodiment of the present invention, FIG. 12 is a view of a portion indicated by the arrow G in FIG. 11, and FIG. 13 is a sectional view taken along line H-H in FIG. 11. The entire structure of the fifth embodiment is also the same as that of the first embodiment described above, except for a method of latching the accordion spring 17 in the axial direction. More specifically, in the fifth embodiment, the first column portion 37 is formed to be extended up to the second flange portion 35 and, at the same time, a slit 55 is formed in a part of the first column portion 37. The bent portion of the nip portion 41 is fitted in this slip 55. Thereby, like in the other embodiments, the accordion spring 17 is prevented from moving in the direction of the outer diameter by the latch protrusion 45 and, at the same time, from moving in the axial direction by the fitting with the slit 55.

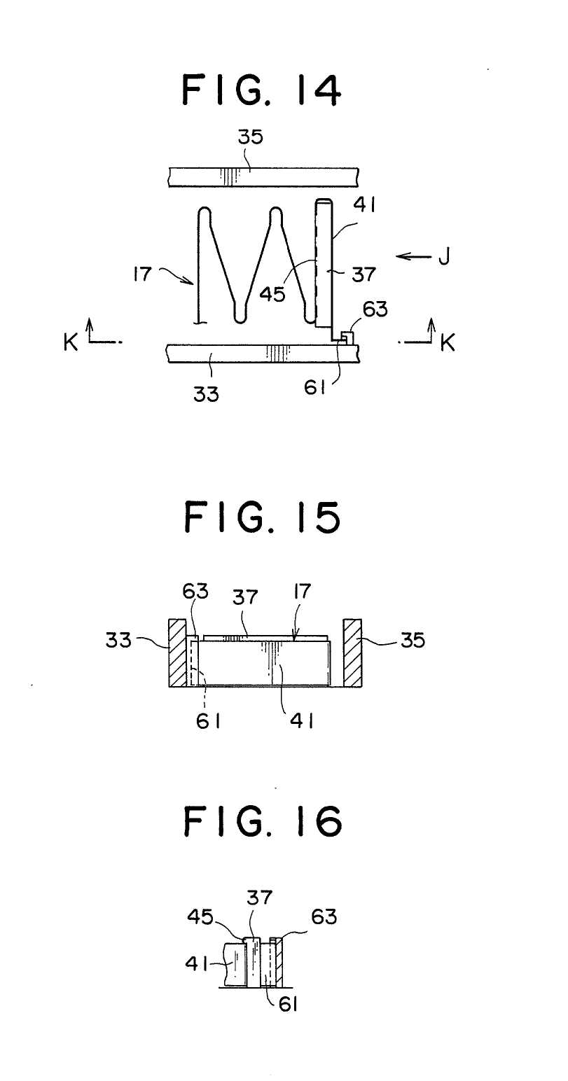

FIG. 14 is a principal enlarged view of a oneway clutch device according to the sixth embodiment of the present invention, FIG. 15 is a view of a portion indicated by the arrow J in FIG. 14, and FIG. 16 is a sectional view taken along line K-K in FIG. 14. The entire structure of the sixth embodiment is also the same as that of the first embodiment described above, except for a method of latching the accordion spring 17 in the axial direction. More specifically, in the sixth embodiment, while the according spring 17 is provided with a bent portion 61 which is formed to extend from the nip portion 41 to have a substantially L-shaped section, the first flange portion 33 is provided with a retaining portion 63 to latch this bent portion 61. Thereby, the accordion spring 17 is prevented from moving in the direction of the outer diameter by the latch protrusion 45, like in the first embodiment, and at the same time, from moving in the axial direction by the engagement between the bent portion 61 and the retaining portion 63.

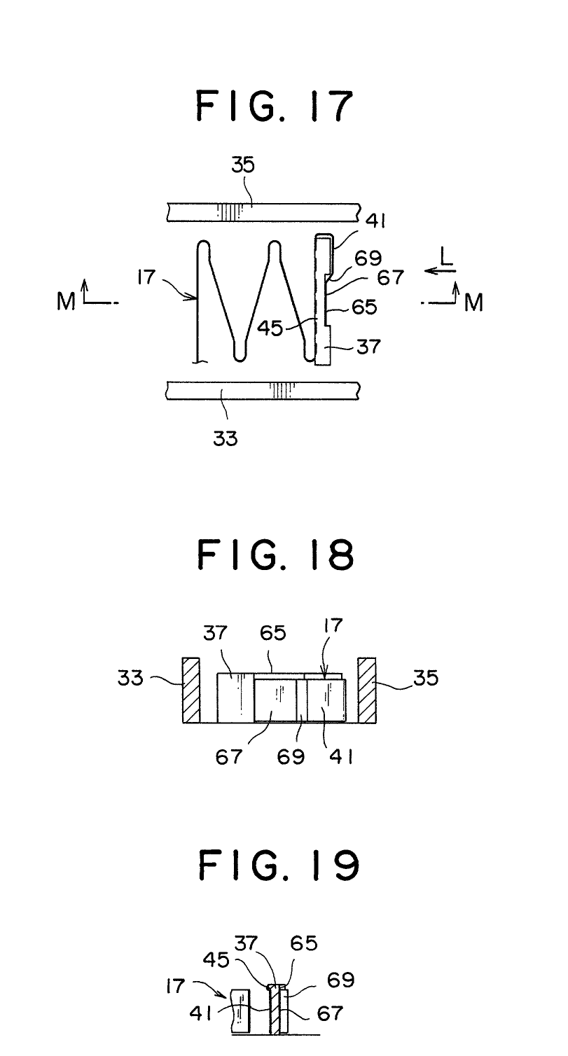

FIG. 17 is a principal enlarged view of a oneway clutch device according to the seventh embodiment of the present invention, FIG. 18 is a view of a portion indicated by the arrow L in FIG. 17, and FIG. 19 is a sectional view taken along line MM in FIG. 17. The entire structure of the seventh embodiment is also the same as that of the first embodiment described above, except for a method of latching the accordion spring 17 in the axial direction. More specifically, in the seventh embodiment, while a recessed portion 65 is formed on a surface of the first column portion 37 on the block bearing 19 side, the according spring 17 is provided with a fit portion 67 which is formed to be fitted in this recessed portion 65. Thereby, like in the first embodiment, the accordion spring 17 is prevented from moving in the direction of the outer diameter by the latch protrusion 45 and, at the same time, from moving in the axial direction by the engagement between the recessed portion 65 and the fit portion 67. In the seventh embodiment, a bent position 69 of the fit portion 67 is formed slantingly.

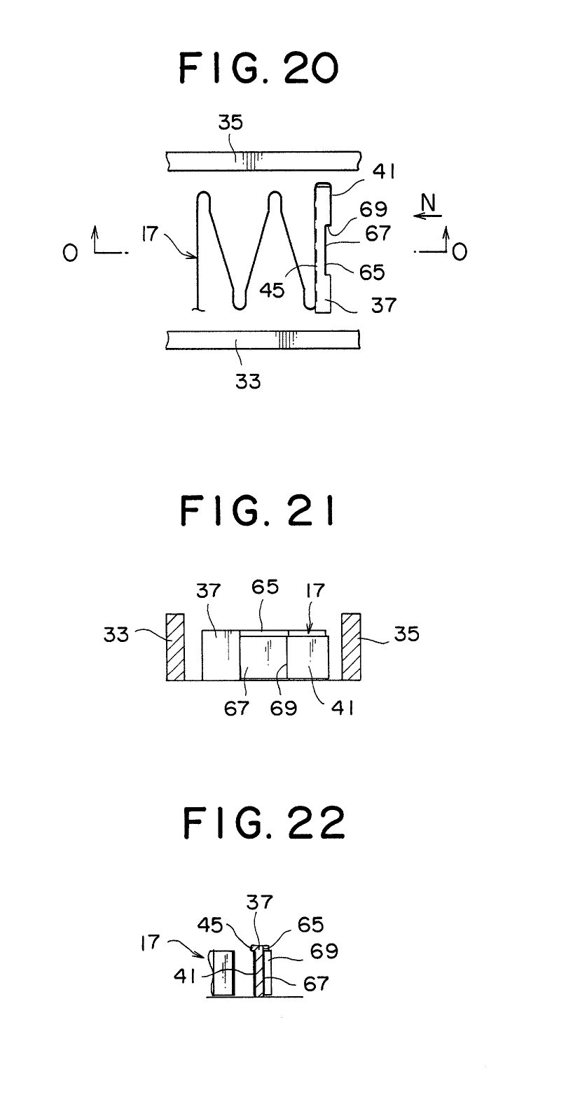

FIG. 20 is a principal enlarged view of a oneway clutch device according to the eighth embodiment of the present invention, FIG. 21 is a view of a portion indicated by the arrow N in FIG. 20, and FIG. 22 is a sectional view taken along line O-O in FIG. 20. The structure and the operation of the eighth embodiment are also substantially the same as those of the seventh embodiment described above, except that the shape of the fit portion 67 of the accordion spring 17 is partially different. More specifically, in the eighth embodiment, the bent position 69 of the fit portion 67 is formed to have a right angle so that it is more difficult for the accordion spring 17 to move in the axial direction.

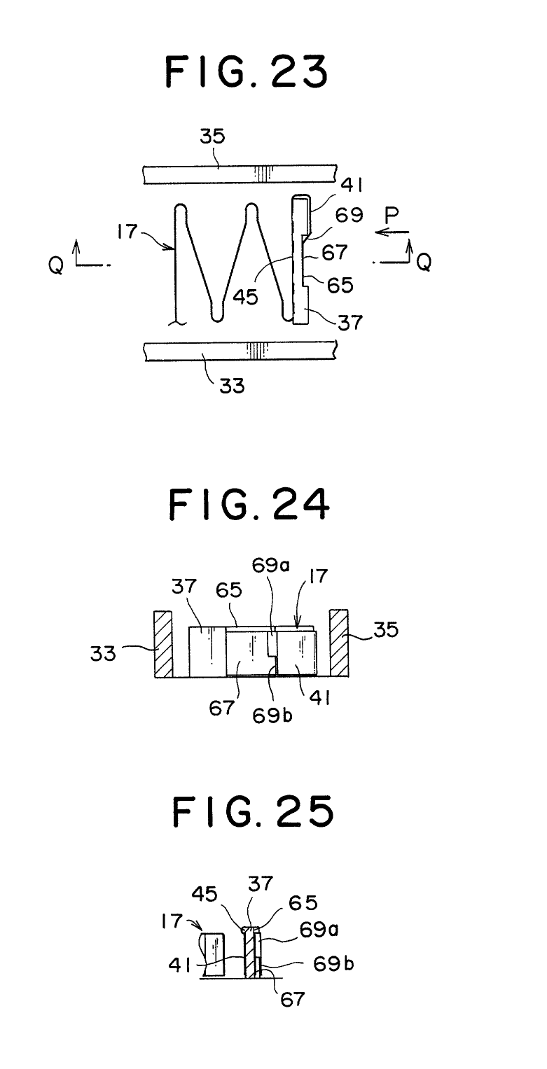

FIG. 23 is a principal enlarged view of a oneway clutch device according to the ninth embodiment of the present invention, FIG. 24 is a view of a portion indicated by the arrow P in FIG. 23, and FIG. 25 is a sectional view taken along line Q-Q in FIG. 23. The structure and the operation of the ninth embodiment are also substantially the same as those of the seventh embodiment described above, except that the shape of the fit portion 67 of the accordion spring 17 is partially different. More specifically, in the ninth embodiment, while a half 69a on the outer diameter side of the bent position 69 of the fit portion 67 is formed slantingly, the other half 69b on the inner diameter side is brought into contact with the inner surface of the recessed portion 65 as if being cut up, so that it becomes more difficult for the accordion spring 17 to move in the axial direction.

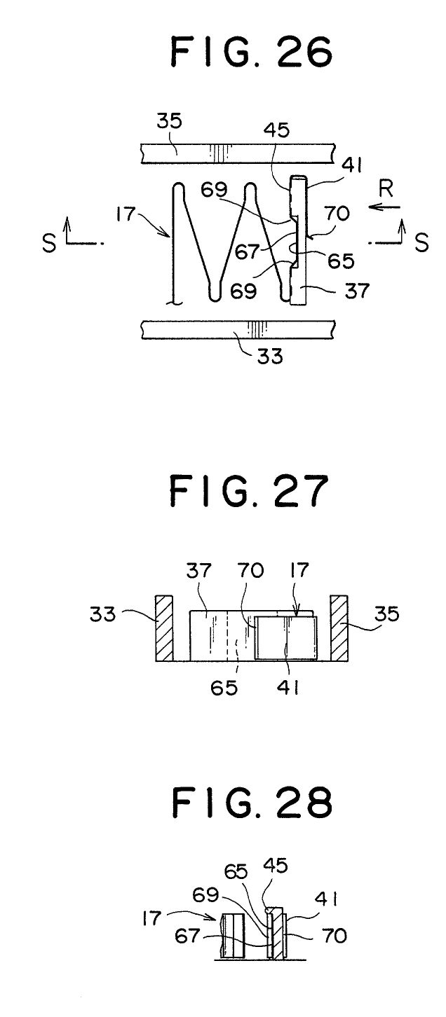

FIG. 26 is a principal enlarged view of a oneway clutch device according to the tenth embodiment of the present invention, FIG. 27 is a view of a portion indicated by the arrow R in FIG. 26, and FIG. 28 is a sectional view taken along line S-S in FIG. 26. The structure and the operation of the tenth embodiment also are substantially the same as those of the seventh embodiment described above, except that the recessed portion 65 is formed on the surface on the side of the roller 11 of the first column portion 37 while the fit portion 67 of the accordion spring 17 is formed at a position corresponding thereto. Note that, in the tenth embodiment, two bent positions 69 of the fit portion 67 are formed slantingly. In addition, a folded-back portion 70 is formed at the tip end of the nip portion 41 so that the accordion spring 17 is easily assembled into the first column portion 37.

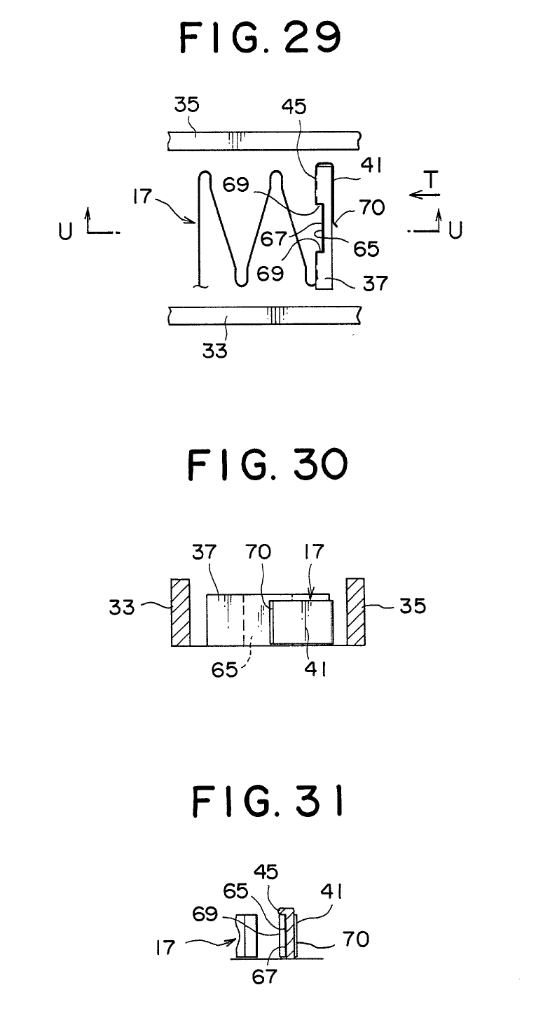

FIG. 29 is a principal enlarged view of a oneway clutch device according to the eleventh embodiment of the present invention, FIG. 30 is a view of a portion indicated by the arrow T in FIG. 29, and FIG. 31 is a sectional view taken along line U-U in FIG. 29. The structure and the operation of the eleventh embodiment are also substantially the same as those of the tenth embodiment described above, except that the shape of the fit portion 67 of the accordion spring 17 is partially different. More specifically, in the eleventh embodiment, the bent position 69 of the fit portion 67 is formed to have a right angle so that it is more difficult for the accordion spring 17 to move in the axial direction.

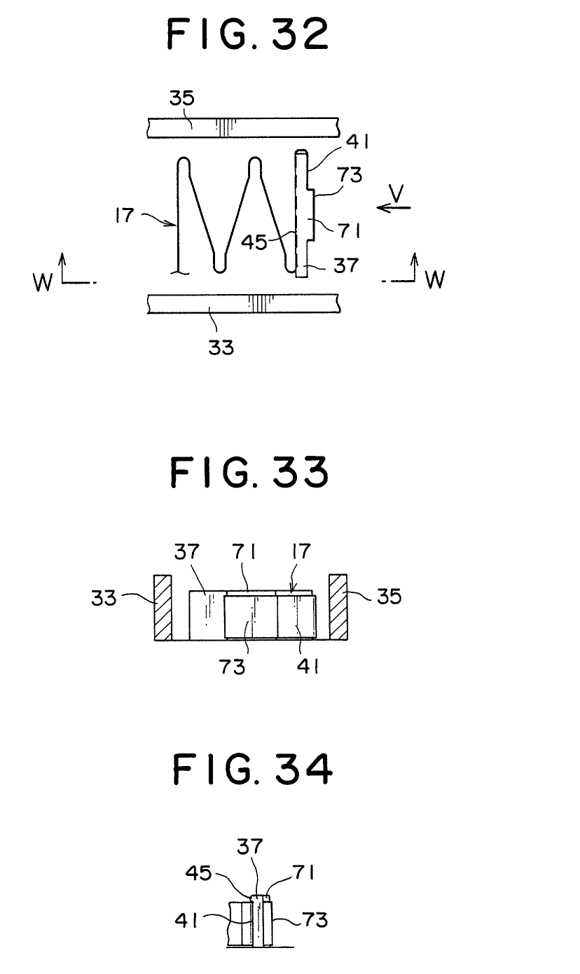

FIG. 32 is a principal enlarged view of a oneway clutch device according to the twelfth embodiment of the present invention, FIG. 33 is a view of a portion indicated by the arrow V in FIG. 32, and FIG. 34 is a sectional view taken along line W-W in FIG. 32. The entire structure of the twelfth embodiment is also the same as that of the first embodiment described above, except for a method of latching the accordion spring 17 in the axial direction. More specifically, in the twelfth embodiment, while a convex portion 71 is formed on a surface of the first column portion 37 on the block bearing 19 side, the accordion spring 17 is provided with an engagement portion 73 which is formed to be engaged with this convex portion 71. Thereby, like in the first embodiment, the accordion spring 17 is prevented from moving in the direction of the outer diameter by the latch protrusion 45 and, at the same time, from moving in the axial direction by the engagement between the convex portion 71 and the engagement portion 73.

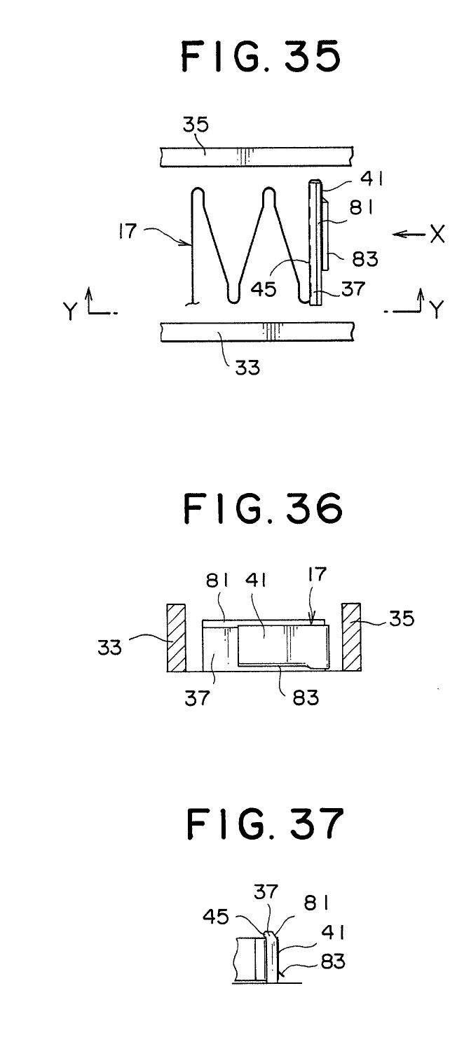

FIG. 35 is a principal enlarged view of a oneway clutch device according to the thirteenth embodiment of the present invention, FIG. 36 is a view of a portion indicated by the arrow X in FIG. 35, and FIG. 37 is a sectional view taken along line Y-Y in FIG. 35. The entire structure of the thirteenth embodiment is also the same as that of the first embodiment described above, except that enhancement of the workability in assembling of the accordion spring 17 is contrived. More specifically, in the thirteenth embodiment, while a portion 81 on the side of the block bearing 19 on the outer diameter side of the first column portion 37 is chamfered, a folded-back portion 83 is formed on the inner diameter side of the accordion spring 17. Thereby, when the accordion spring 17 is assembled in the first column portion 37, the nip portion 41 is easily folded out so that the manufacturing efficiency is largely enhanced.

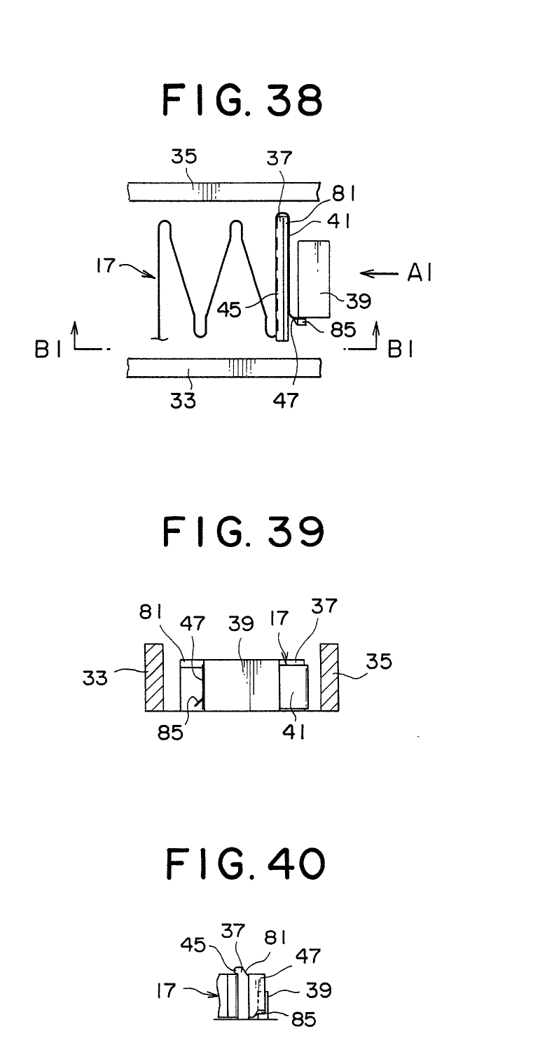

FIG. 38 is a principal enlarged view of a oneway clutch device according to the fourteenth embodiment of the present invention, FIG. 39 is a view of a portion indicated by the arrow A1 in FIG. 38, and FIG. 40 is a sectional view taken along line B1-B1 in FIG. 38. The entire structure of the fourteenth embodiment is also the same as that of the first embodiment described above, except that enhancement of the workability in assembling of the accordion spring 17 is contrived. More specifically, in the fourteenth embodiment, while a portion 81 on the side of the block bearing 19 on the outer diameter side of the first column portion 37 is chamfered, a folded-back portion 85 is formed in the latch portion 47 of the accordion spring 17. Thereby, when the accordion spring 17 is assembled in the first column portion 37, while the nip portion 41 is easily folded out, the latch portion 47 is also easily elastically deformed, so that the manufacturing efficiency is largely enhanced.

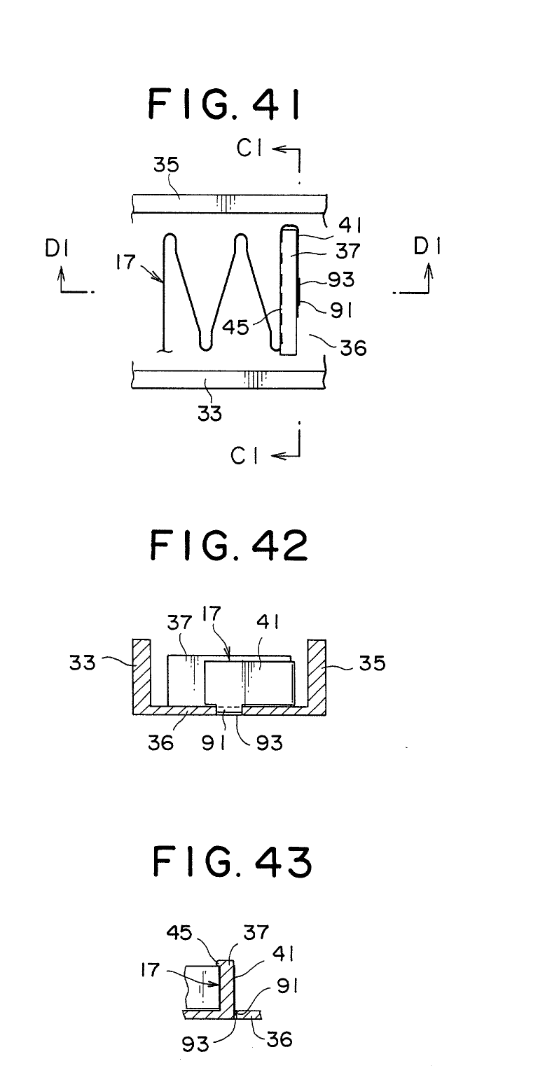

FIG. 41 is a principal enlarged view of a oneway clutch device according to the fifteenth embodiment of the present invention, FIG. 42 is a sectional view taken along line Cl-Cl in FIG. 41, and FIG. 43 is a sectional view taken along line D1-D1 in FIG. 41. The entire structure of the fifteenth embodiment is also the same as that of the first embodiment described above, except for a method of latching the accordion spring 17 in the axial direction. More specifically, in the fifteenth embodiment, while a latch portion 91 is formed in the vicinity of the end portion on the fixed side of the accordion spring 17 to be protruded toward the inner diameter side, the connection unit 36 is provided with a through hole 93 for receiving this latch portion 91. Thereby, like in the first embodiment, the accordion spring 17 is prevented from moving in the direction of the outer diameter by the latch protrusion 45 and, at the same time, from moving in the axial direction by the engagement between the latch portion 91 and the through hole 93.

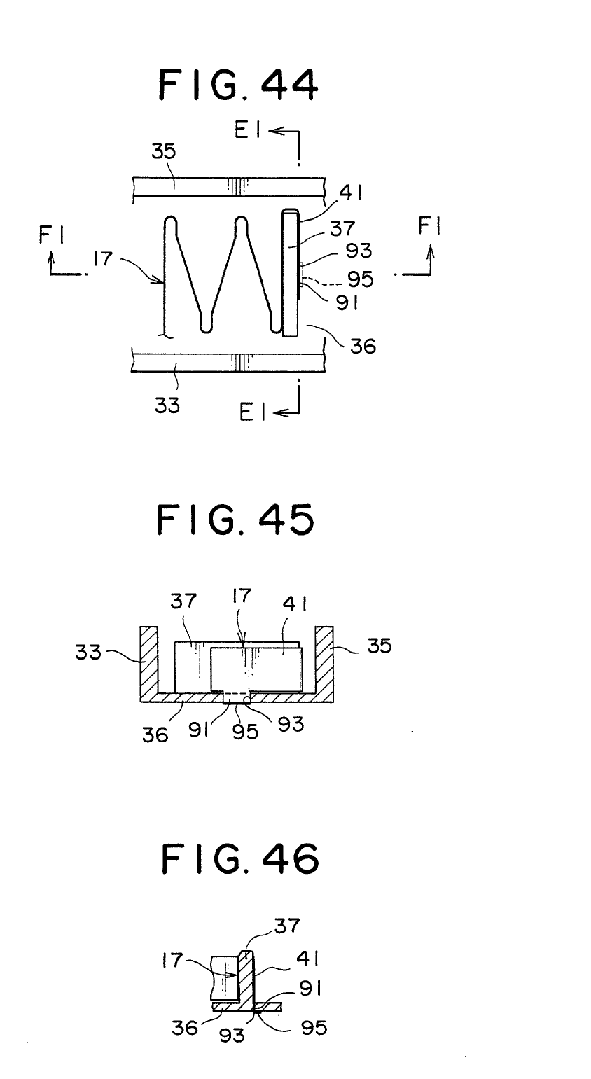

FIG. 44 is a principal enlarged view of a oneway clutch device according to the sixteenth embodiment of the present invention, FIG. 45 is a sectional view taken along line El-El in FIG. 44, and FIG. 46 is a sectional view taken along line F1-F1 in FIG. 44. The entire structure of the sixteenth embodiment is also the same as that of the fifteenth embodiment described above, except for a method of latching the accordion spring 17 in the direction of the outer diameter. More specifically, in the sixteenth embodiment, no latch protrusion is provided for preventing the movement of the accordion spring 17 in the outer diameter direction, and a folded-back portion 95 is formed at the tip end of the latch portion 91. Thereby, the accordion spring 17 is prevented from moving in the axial direction by the engagement between the latch portion 91 and the through hole 93, like in the fifteenth embodiment, but is prevented from moving in the direction of the outer diameter by the engagement between the folded-back portion 95 and the connection unit 36.

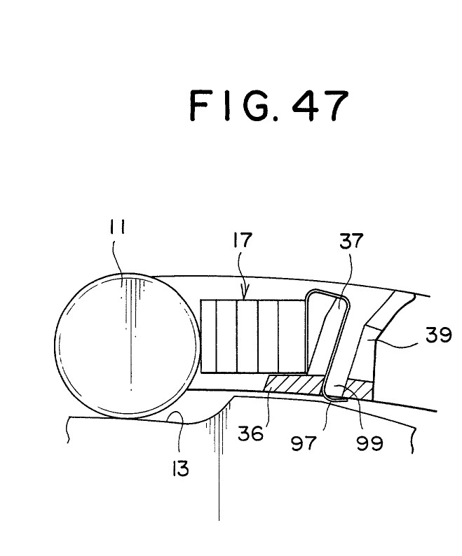

FIG. 47 is a principal enlarged view of the oneway clutch device according to the seventeenth embodiment. The entire structure of the seventeenth embodiment is also the same as that of the first embodiment described above, except for the shape of the accordion spring 17 and a method of latching the accordion spring 17 in the direction of the outer diameter and in the axial direction. More specifically, in the seventeenth embodiment, the end portion on the fixed side of the accordion spring 17 is formed to be extended on the outer diameter side as if going around the first column portion 37. In addition, in the connection unit 36, a through hole 99 is formed between the first column portion 37 and the second column portion 39 in such a manner that the latch portion 97 of the accordion spring 17 passes through this through hole 99. Thereby, the accordion spring 17 is prevented from moving in the direction of the outer diameter by the engagement between the latch portion 97 and the second column portion 39 and is prevented from moving in the axial direction by the engagement between the latch portion 97 and the through hole 93.

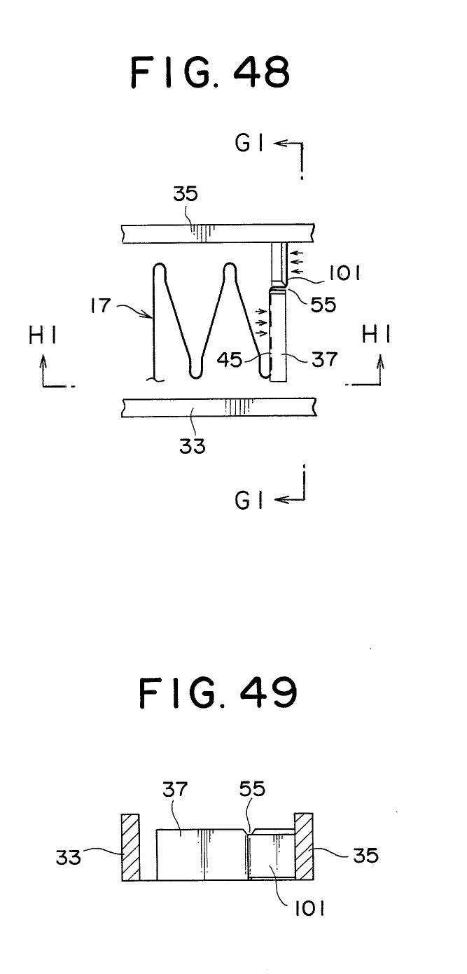

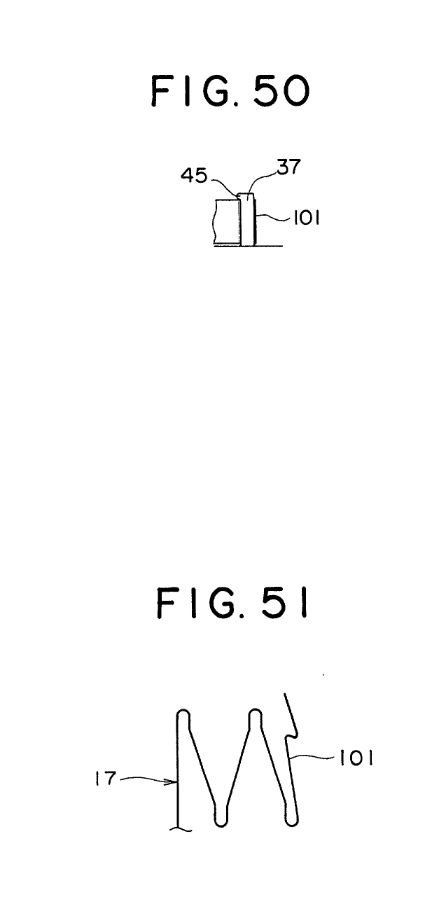

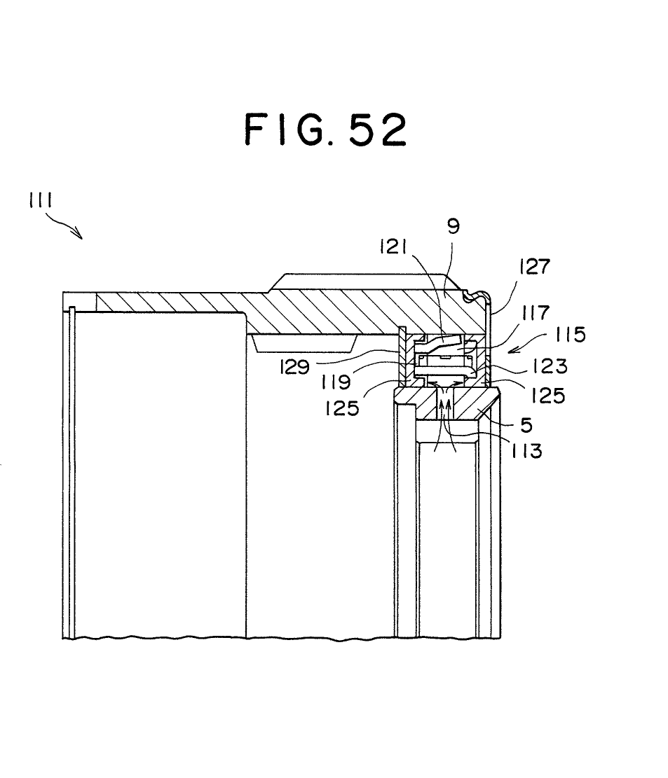

FIG. 48 is a principal enlarged view of a oneway clutch device according to the eighteenth embodiment of the present invention, FIG. 49 is a sectional view taken along line G1-G1 in FIG. 48, and FIG. 50 is a sectional view taken along line H1-H1 in FIG. 48. The entire structure of the eighteenth embodiment is also the same as that of the first embodiment described above, except that a retaining portion 101 which is bent substantially in a Z form is formed in the end portion on the fixed side of the accordion spring 17. In addition, like in the fifth embodiment, the first column portion 37 is formed to be extended to the second flange portion 35 and, at the same time, a slit 55 is formed in a part thereof. The bent portion of the retaining portion 101 is fitted in this slit 55. Thereby, like the other embodiments, the accordion spring 17 is prevented from moving in the direction of the outer diameter by the latch portion 45 and, at the same time, prevented from moving in the axial direction by the fit between the retaining portion 101 and the slit 55. Note that the retaining portion 101 is bent at an acute angle in a free state, as shown in FIG. 51, and is brought into elastic contact with the first column portion 37 with a predetermined elastic contacting force in the assembled state in FIG. 48.

The description of the specific embodiments of the present invention is as seen above. However, the present invention is not limited to these embodiments. Though in each of the foregoing embodiments the present invention is applied to what employs the accordion spring as a spring for biasing the rollers, it may be applied also to what employs other kinds of springs such as a coil spring. It is also possible to properly change the entire structure of the oneway clutch device and the specific form, etc., of each constituent part, as well as a specific method of latching a spring, within the scope and the spirit of the present invention.

According to the oneway clutch device of the present invention, a fall-off, or the like, of the spring hardly occurs during the conveyance, or the like, of the sub-assemblies. As a result, a smooth assembling work can be realized.

What is claimed is:

1. A oneway clutch device comprising:
a plurality of rollers interposed between an inner race and an outer race to transmit torque only at the time of relative rotation between the inner race and the outer race in one rotational direction;
a spring for biasing these rollers toward a direction of engagement; and
a retainer having a flange portion to be fitted on the inner race and a plurality of column portions and adapted to retain the rollers and the spring,
wherein the spring has a nip portion formed and bent to have a section substantially in a U form for nipping and retaining therebetween one of the column portions of the retainer, and there is formed at least one latch means for preventing movement or falling off of the spring.

2. The oneway clutch device according to claim 1, wherein one of said latch means is a latch protrusion which is formed on the outer diameter side of said column portion for latching said nip portion in order to regulate a movement of the spring in the direction of the outer diameter.

3. The oneway clutch device according to claim 1 or 2, wherein one of said latch means is a latch portion which is formed to be extended from the tip end of the nip portion, so as to be engaged with the column portion of said retainer.

4. The oneway clutch device according to claim 1 or 2, wherein one of said latch means is a contact portion which is formed to be folded back at the tip end of the nip portion so as to be brought into contact with the flange portion of said retainer.

5. The oneway clutch device according to claim 1 or 2, wherein one of said latch means is a contacting protrusive piece which is formed to be protruded from the bent portion of the nip portion so as to be engaged with the flange portion of said retainer.

6. The oneway clutch device according to claim 1 or 2, wherein one of said latch means is a slit which is formed in the column portion so as to receive the bent portion of the nip portion.

7. The oneway clutch device according to claim 1 or 2, wherein one of said latch means comprises the bent portion which is formed to be extended from the tip end of the nip portion to have a section substantially in an L form and a retaining portion which is formed in the column portion for retaining the bent portion.

8. The oneway clutch device according to claim 1 or 2, wherein one of said latch means comprises a recessed portion which is formed in the column portion and a fit portion which is formed in the nip portion to be fitted in the recessed portion.

9. The oneway clutch device according to claim 1 or 2, wherein one of said latch means comprises a convex portion which is formed in the column portion and an engagement portion which is formed in the nip portion to be engaged with the convex portion.

10. The oneway clutch device according to claim 1 or 2, wherein one of said latch means comprises a through hole which is formed among said plurality of column portions in the retainer and a protrusive portion which is formed to be protruded from the nip portion to be fitted in the through hole.

11. The oneway clutch device according to claim 1 or 2, wherein one of said latch means comprises a through hole which is formed among said plurality of column portions in the retainer and a fit latching portion having a substantially L shape, which is formed to be protruded from the nip portion to be fitted in the through hole to be latched.

12. The oneway clutch device according to claim 1 or 2, wherein the column portion has a chamfered portion in the end portion on the outer diameter side, in order to facilitate an assembling work of the spring.

13. The oneway clutch device according to claim 1 or 2, wherein the spring has a folded-back portion in the end portion on the inner diameter side, in order to facilitate the assembling work of the spring into the column portion.

14. A oneway clutch device comprising:
a plurality of rollers interposed between an inner race and an outer race to transmit torque only at the time of relative rotation between the inner race and the outer race in one rotational direction;
a spring for biasing these rollers toward a direction of engagement; and
a retainer having a flange portion to be fitted on the inner race and a plurality of column portions, and adapted to retain the rollers and the spring,
wherein the spring has a retaining portion formed and bent to have a section substantially in a Z form for elastically contacting with and retaining one of the column portions of the retainer, a slit through which the bent portion of the nip portion is if formed to be fitted in the column portion, and at least one latch means is formed for preventing movement or falling off of the spring.

15. The oneway clutch device according to claim 14, wherein one of said latch means is a latch protrusion which is formed on the outer diameter side of said column portion for latching said retaining portion in order to regulate the movement of the spring in the direction of the outer diameter.
